(19) United States
(12) Patent Application Publication
(10) Pub. No.: US 2024/0095770 A1
(43) Pub. Date: Mar. 21, 2024

(54) SYSTEMS AND METHODS FOR INCENTIVIZING CONTENT EXPLORATION

(71) Applicant: Valve Corporation, Bellevue, WA (US)

(72) Inventors: Adil Sardar, Seattle, WA (US); Sarah Kneller, Mukilteo, WA (US); Alden Kroll, Seattle, WA (US); John Shaw, Bellevue, WA (US)

(21) Appl. No.: 17/939,286

(22) Filed: Sep. 7, 2022

(51) Int. Cl. G06Q 30/02; H04L 9/32

(52) U.S. Cl. CPC G06Q 30/0211; G06Q 30/0224; H04L 9/3213

(57) ABSTRACT

There may be large numbers of content items available at current content provider systems. Incentive items may be inserted among content items, for example, associated with content categories, that may reward uses for viewing content items. When incentive items are selected by a user, the user may be associated with credit towards a bonus item or award a bonus item. Incentive items may have associated preference factors that may be manipulated to increase the probability of such incentive items being presented to the user.

### BACKGROUND

As the consumption of content items on electronic devices has continued to proliferate, so has the amount of available content items and information regarding these content items. For example, the number of songs, movies, television shows, and games available for streaming or download has increased substantially in the recent past. While this increase in available content items is generally beneficial to users, presenting content items and information of potential interest to individual users may be challenging due, in part, to the large number of available content items and limited screen area on which to present them.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a diagram illustrating an example environment that includes a video game distribution platform and multiple client computing devices configured to implement the techniques described herein.

FIGS. 2A-B illustrate example user interfaces (UIs) that the video game distribution platform of FIG. 1 may provide to a client computing device of FIG. 1 in accordance with examples of the disclosure.

FIG. 3 is a flow diagram of an example process for determining and presenting content items on a client computing device in accordance with examples of the disclosure.

FIG. 4 is a flow diagram of an example process for determining and including treasure items in candidate content items for presentation on a client computing device in accordance with examples of the disclosure.

FIG. 5 is a flow diagram of an example process for facilitating the redemption of treasure items and prizes via a client computing device in accordance with examples of the disclosure.

FIG. 6 is a computer architecture diagram showing an example computer hardware architecture for implementing computing devices configured to implement the techniques described herein.

### DETAILED DESCRIPTION

Described herein are, among other things, techniques, devices, and systems for generating and presenting incentive items among content-item presented to a user in a user interface based at least in part on data that is unique to the respective user and/or the type of content items considered for presentation in the user interface. For instance, one or more incentive items (“treasure” items) may an included among the content item presented to a user in response to a user requesting presentation of content items associated with a particular content genre or other criteria. In response to user selection of such incentive items, a system as described herein may associate incentive data to a user that the system may use to determine whether the user qualifies for a virtual item and/or other prize data. The system may use historical user incentive response and/or selection data to determine a presentation order and/or location of one or more unredeemed incentive items among presented content items that increases the likelihood of incentive item selection by the user.

In various examples, a remote computing system that offers one or more content items, such as game titles, for acquisition may group such items into various categories. These categories may be associated with content genres (e.g., racing games, role playing games, action games, strategy games, etc.), content types (e.g., single player, multiplayer, etc.), content themes (e.g., anime, horror, space, open world, etc.), content availability (e.g., new release, demo, free, on sale, discounted, promotions, limited time availability, etc.), and/or any other criteria that may be associated with a content item. A particular content item may be associated with one or more content categories. In some examples, a category of “all” may include all available content items and one or more other categories may be a subset of the “all” category.

To facilitate user acquisition and/or interaction with content items, the remote computing system may present (e.g., indications of) the content items associated with a particular category on a user interface. However, there may be a larger number of content items associated with the particular category than can be clearly presented on a single user interface. For example, the remote computing system may be configured to generating and/or present a user interface that has a defined number (e.g., 4, 6, 8, 10, etc.) of icons representing content items, while there may be many more than the defined number of content items available in that category. Therefore, the remote computing system may determine a subset of the available content items in a particular category for presentation on a user interface. The remote computing system may also configure the user interface to also include a selectable control allowing the user to request another user interface with another (e.g., distinct) subset of the available content items associated with the category.

There are various techniques that the remote computing system may use to determine that content item subset to be represented on any particular user interface. For example, the remote computing system may place content item icons on a series of user interfaces in order of popularity (e.g., prioritizing more popular items). Alternatively or additionally, the remote computing system may place content item icons on a series of user interfaces in order of availability (e.g., prioritizing newer items, limited time items, expiring items, based on availability dates, etc.). Alternatively or additionally, the remote computing system may place content item icons on a series of user interfaces in an order determined based on user preferences and/or history (e.g., prioritizing items based on user-preferred and/or historically selected theme, type, genre, etc.). Alternatively or additionally, the remote computing system may place content item icons on a series of user interfaces randomly.

While the order of presentation of content items on user interfaces may facilitate presenting items of greater interest to the user, the order of presentation may also result in preventing the user's exposure to a potentially significant portion of the items in a category because the user may often select an item in the first few user interfaces in a series without viewing items in later interfaces. To increase the presentation of content items to a user, the disclosed systems and methods may be used to generate user interfaces that increase user interaction with various content items associated with content categories.

For example, a remote computing system may generate and/or determine one or more incentive items (e.g., “treasure” items) that the remote computing system may include among content items that may presented to a user in one or more user interfaces. The remote computing system may determine whether a particular user is eligible for an incentive item based on various criteria, such user interactions with the system (e.g., exploration control selections (e.g., forward, back, next page, show more, etc.), content item selections, content item previews, etc.). If a user is associated with a sufficient (e.g., threshold) quantity of interactions, the system may determine to present an incentive item to the user. The threshold of sufficient quantity of interactions may increase over time, so that the user may be presented a first incentive item relatively quickly but may have to perform increasingly larger numbers of interaction with the system to be presented with subsequent incentive items.

Incentive items may, upon user selection, provide a benefit and/or content to a user. For example, an incentive item may include or provide a means of obtaining one or more bonus items (e.g., game credit, booster, badge, level up, etc.). Such bonus items may include graphical assets, such as emoticons (e.g., chat emoticons), profile badges, profile levels, profile decorations (e.g., background images, skins, avatars, avatar frames, etc.) etc. Alternatively or additionally, an incentive item may include or provide a means of obtaining credit towards one or more such bonus items. For example, a user may be provided a bonus item after obtaining a number (e.g., 5, 8, 10, etc.) of incentive items. In various example, the user may be presented with a selection of bonus items to choose from upon obtaining a number of incentive items.

An incentive item may also, or instead, include content with which a user may interact. For example, an incentive item may include a trivia question that a user may answer to obtain a bonus item and/or credit towards a bonus item. In another example, an incentive item may include a game (e.g., a brief game) that a user may play to obtain a bonus item and/or credit towards a bonus item. In various examples, an incentive item may also, or instead include a clue or hint associated with finding additional inventive items and/or finding one or more bonus items. For example, an incentive item may include a listing of one or more categories where other incentive items may be located (e.g., that may be redeemed for credit towards a bonus item).

The remote computing system may determine the placement of incentive items among content items in a category based on one or more criteria. In examples, the remote computing system may use a preference factor that may be determined based on such criteria to determine incentive item placement. A preference factor may be used to increase and/or decrease the likelihood of presenting an incentive item on earlier user interfaces. In various examples, the remote computing system may track a quantity of interactions by a user (e.g., exploration control selections (e.g., forward, back, next page, show more, etc.), content item selections, content item previews, etc.) and may adjust a preference factor based on such interactions. In some such examples, the system may make it progressively more difficult to find incentive items. For instance, the remote computing system may determine to insert an incentive item on an earlier user interface, or within a higher portion of the content items more likely to be presented on an earlier presented user interface, such that the incentive item is more likely to be presented to the user. The system may then adjust the preference factor so that, as the user interaction increases, the incentive item is more likely to be presented on a later user interface, or within a lower or greater portion of the content items more likely to be presented on a later presented user interface. In this way, incentive items may become more challenging to locate over time. Alternatively or additionally, the system may make it progressively easier to find incentive items by adjusting the incentive factor over time and/or user interaction such that the incentive items are more likely to be presented to a user earlier.

In various examples, a preference factor may represent a denominator of a fraction of potential user interfaces in one of which the incentive item will be presented. For instance, if the preference factor is two, the remote computing system may determine a user interface in which the incentive item will be presented from among the top half (½) of the user interfaces (e.g., into one of the first five user interfaces in a series of ten). In another example, if the preference factor is 10, the remote computing system may determine a user interface in which the incentive item will be presented from among the top tenth ( 1/10) of the user interfaces (e.g., into the first user interface in a series of ten). In such examples where discovering incentive items is intended to become more challenging over time and/or user interactions, the preference factor may start at a relatively high value (e.g., 10) and may be reduced over time and/or interactions, while in examples where discovering an incentive items is intended to become easier over time and/or interactions, the preference factor may start at a relatively low value (e.g., 1) and may be increase over time and/or interactions.

The preference factor may instead, or in addition, represent a denominator of a fraction of ordered candidate content items to be presented in user interfaces. For instance, if the preference factor is two, the remote computing system may determine that the incentive item is to be inserted into the top half (½) portion of the candidate content items (e.g., into the first 50 of 100 candidate content items). In another example, if the preference factor is 10, the remote computing system may determine that the incentive item is to be inserted into the top tenth ( 1/10) portion of the candidate content items (e.g., into the first 10 of 100 candidate content items). In such examples where discovering incentive items is intended to become more challenging over time and/or user interactions, here again the preference factor may start at a relatively high value (e.g., 10) and may be reduced over time and/or interactions, while in examples where discovering an incentive items is intended to become easier over time and/or interactions, the preference factor may start at a relatively low value (e.g., 1) and may be increase over time and/or interactions. Alternatively or additionally, the remote computing system may determine placement of an incentive item within a determined portion of user interfaces or candidate content items randomly and/or using one or more other placement determination techniques.

For example, the remote computing system may user historical user interaction data to determine a preference factor and/or incentive item placement. If a user has had no interaction (e.g., within a threshold period of time) with the content items available at the remote computing system and/or with one or more particular subsets of such content items (e.g., items in one or more particular categories), the remote computing system may set a preference factor for an incentive item to one. Because the preference factor indicates that the incentive item may be placed anywhere among all candidate content items (e.g., preference factor is 1/1), the remote computing system may randomly insert the incentive item among the ordered candidate content items to be presented to the user in a series of user interfaces. For instance, the remote computing system may detect a user request to display the content items in the “action” genre and may determine a prioritized set of 100 candidate content items. Based on a preference factor of one, the remote computing system may then randomly determine a number (e.g., 45) from among the number of candidate content items. The remote computing system may then use this randomly determined number for the incentive item to determine when to present the incentive item to the user (e.g., to present the incentive item as, or following, the 45^{th} candidate content item.

The remote computing system may track the user's interaction with content items and/or user interfaces and determine preference factor adjustments based on such interaction. For example, if the user has selected a content item for acquisition or interaction from among a set of candidate content items without selecting an incentive item that was included in the set of candidate content items, the remote computing system may increase (e.g. increment, double, etc.) the preference factor associated with the incentive item. In another example, if the user has performed an action other than selecting the incentive item that was included in the set of candidate content items (e.g., selecting a control to navigate to a next interface with additional content items), the remote computing system may increase (e.g. increment, double, etc.) the preference factor associated with the incentive item. At a subsequent request for presentation of content items (e.g., a new request for content associated with a category or a request for subsequent content items associated with the same category), the remote computing system may use this increased preference factor in determining the placement of the incentive item among candidate content items. If the incentive item remains unselected for a subsequent presentation of candidate content items, the remote computing system may again increase the associated preference factor, and so forth, until, in some examples, the incentive item is placed on the first user interface presented to a user with candidate content items.

In some examples, a preference factor may be associated with an individual incentive item, while in other examples, a preference factor may be associated with a user. When associated with a user, if the user selects an incentive item, the preference factor may be reset (e.g., to one) in some examples while it may be retained at a current level following incentive item selection in other examples. In some examples, a preference factor may increase or decrease over time (e.g., based on a length of time since user interaction was detected).

Preference factors and incentive item placement may be dynamic and/or user specific. For example, the remote computing system may determine placement of an incentive item in response to a particular request from particular user for the presentation of one or more content items. Incentive items may be similar in form and appearance to content items such that they blend in with items represented in user interfaces, thereby encouraging users to examine the represented items closely to spot incentive items.

In response to detecting the selection of an incentive item, the remote computing system may generate an incentive interface that include a redemption link that may provide a means for the user to acquire the associated incentive item (e.g., bonus or credit). In various examples, the remote computing system may generate a token based on the user, user data, the incentive item, incentive item data, and/or other data and encrypt this token using a secret key that may be associated with the user and/or the incentive item and may not be available to any other users and/or systems. The system may also generate a link associated with the encrypted token that will, when activated, transmit the encrypted token back to the system allowing the system to verify that the appropriate user is attempting to redeem the incentive item. Alternatively or additionally, the remote computing system may generate such a link using public key encryption and the user's public key. Other techniques may also, or instead, be used to prevent unauthorized redemption of an incentive item. The user may then acquire the associated credit or bonus item by activating the link using the user's private key. Once the user is verified by this process, the remote system may credit the user's account or profile with the associated bonus or credit. In some examples, hints or clues as to the location of additional incentive items may be provided along with the credit or bonus item associated with the redeemed incentive item.

As noted above, an incentive item may be associated with credit towards a bonus item. In various examples, the remote computing system may determine that a user may acquire a bonus item based on the user selecting, acquiring, or otherwise redeeming one or more incentive items. The remote computing system may determine a particular bonus item to associate with the user (e.g., with the user's account, profile, etc.). Alternatively or additionally, the remote computing system may present a user interface to the user with representations of one or more bonus items that the user may select or otherwise activate to acquire one or more such bonus items. In response to a user selection of one or more bonus items, the remote computing system may associate the bonus item(s) with the user (e.g., with the user's account, profile, etc.).

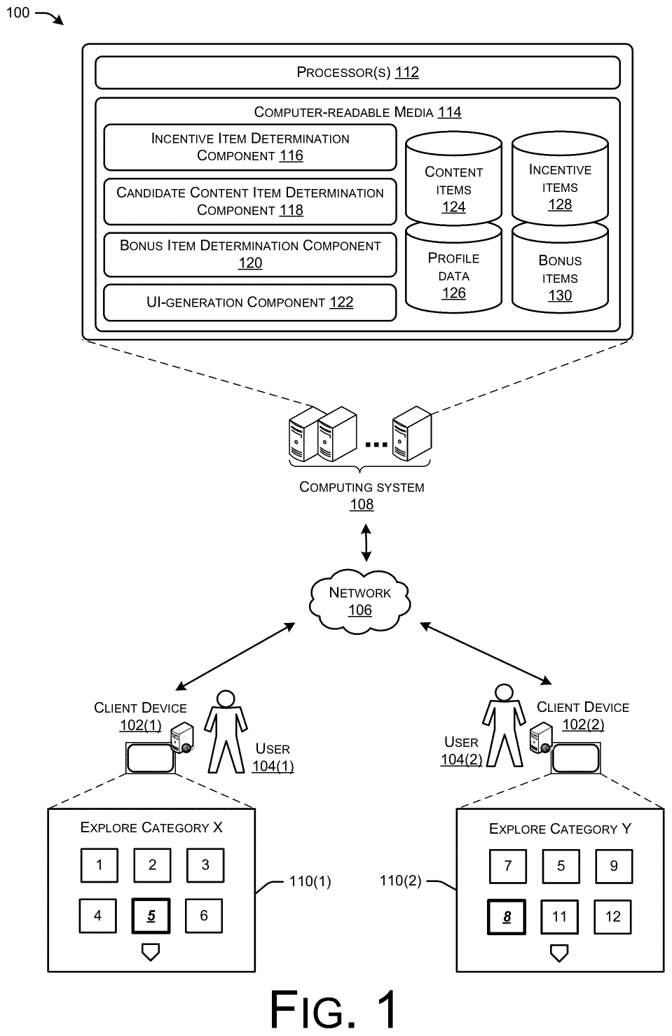

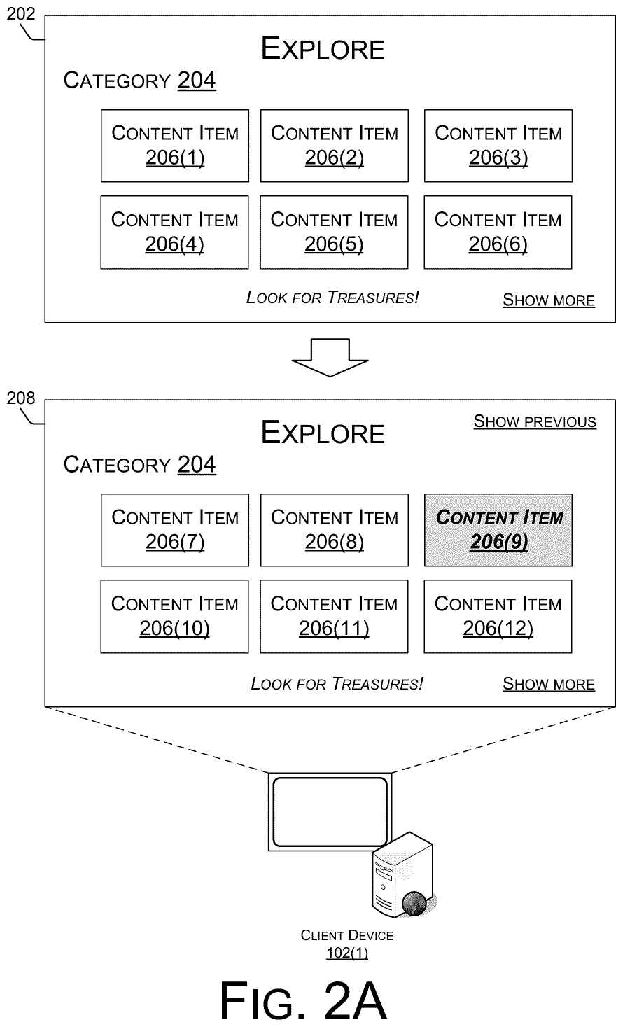

The techniques introduced above are described with reference to FIGS. 1-6. The disclosed techniques may be implemented, at least in part, by a remote computing system that distributes content items (e.g., video games, movies, television shows, songs, game titles, etc.) to client devices of a user community (e.g., as part of a video-game service, movie service, song service, etc.). It is to be appreciated that while these techniques are described with reference to games (e.g., video games), these techniques may apply to any other type of content items, such as books, movies, videos, songs, or the like.

FIG. 1 is a diagram illustrating an example environment 100 that includes a first client computing device (or “client device”) 102(1) operated by a first user 104(1) as well as a second client computing device 102(2) operated by a second user 104(2). As illustrated, the client computing devices 102(1) and 102(2) may communicate with one or more other computing devices over a network 106. For example, the client computing devices 102(1) and 102(2) may communicate via the network 106 with a remote computing system 108 that is configured to provide games and/or other content items to the client computing devices (collectively, “devices 102”).

The client devices 102 may be implemented as any suitable type of computing device configured to execute content items, such as video games, movies, songs, and/or the like. The client devices 102 may comprise, without limitation, a personal computer (PC), a desktop computer, a laptop computer, a mobile phone (e.g., a smart phone), a tablet computer, a portable digital assistant (PDA), a wearable computer (e.g., virtual reality (VR) headset, augmented reality (AR) headset, smart glasses, etc.), an in-vehicle (e.g., in-car) computer, a television (smart television), a set-top-box (STB), a game console, a music player, a voice-controlled assistant, and/or any similar computing device. In some instances, the client devices 102 may include integral displays, while in other instances the client devices may couple to respective display devices. In addition, the client devices 102 may communicate with the remote computing system (“computing system”) 108 over the computer network 106. The computer network 106 may represent and/or include, without limitation, the Internet, other types of data and/or voice networks, a wired infrastructure (e.g., coaxial cable, fiber optic cable, etc.), a wireless infrastructure (e.g., radio frequencies (RF), cellular, satellite, etc.), any other connection technologies, and/or any combination thereof. The computing system 108 may, in some instances be part of a network-accessible computing platform that is maintained and accessible via the computer network 106. Network-accessible computing platforms such as this may be referred to using terms such as “on-demand computing,” “software as a service (SaaS),” “platform computing,” “network-accessible platform,” “cloud services,” “data centers,” and so forth.

In some embodiments, the computing system 108 acts as, or has access to, a video game platform that implements a video game service to distribute (e.g., download, stream, etc.) video games (or any other type of content item) to client devices, such as the client device 102. In an example, each client device may install a client application thereon. The installed client application may be a video-game client (e.g., gaming software to play video games). A client device 102 with an installed client application may be configured to download, stream, or otherwise receive programs (e.g., video games, and content thereof) from the computing system 108 over the computer network 106. Any type of content-distribution model can be utilized for this purpose, such as a direct purchase model where programs (e.g., video games) are individually purchasable for download and execution on a client device 102, a subscription-based model, a content-distribution model where programs are rented or leased for a period of time, streamed, or otherwise made available to the client devices. Accordingly, an individual client device 102 may include one or more installed video games that are executable by loading the client application.

The client device 102 may be used to register with, and thereafter login to, a video game service. A user may create a user account for this purpose and specify/set credentials (e.g., passwords, PINs, biometric IDs, etc.) tied to the registered user account. A user may also, or instead, create a user profile for this purpose that has additional and/or supplemental information (e.g., user information). As a plurality of users interact with the video game platform (e.g., by accessing their user/player profiles with a registered user account, playing video games on their respective client devices, etc.), the client devices send data to the remote computing system 108. The data sent to the remote computing system 108, for a given client device 102, may include, without limitation, user input data, video game data (e.g., game performance statistics uploaded to the remote system), social networking messages and related activity, identifiers (IDs) of the video games played on the client device 102, incentive items redeemed and/or acquired, bonus items redeemed and/or acquired, program (e.g., video game) browsing and/or exploring history and related data, browser data and activity, and so on. This data can be streamed in real-time (or substantially real-time), sent to the remote system 108 at defined intervals, and/or uploaded in response to events (e.g., exiting a video game, selecting a control on a user interface, etc.). This data may be used to determine a gameplay history of the user of the client device 102, preferences of the user, or the like, which may be used to determine which game titles (e.g., content items, incentive items, bonus items, icons representing such items, etc.) to recommend to the user and/or a manner (e.g., an order) in which to recommend the game titles to the user (e.g., in a series of one or more user interfaces), as introduced above and discussed in further detail below.

For instance, the user 104(1) may operate the client device 102(1) to navigate to a webpage or the like associated with the computing system 108 and, in response, the computing system 108 may cause the client device 102(1) to present a user interface (UI) 110(1) on a display of the client device 102(1). In some instances, this UI 110(1) may include information regarding one or more video games and/or other content items available for acquisition by the user 104(1) and from the computing system 108. For instance, the UI 110(1) may include icons associated with the respective game titles, with these icons being selectable by the user 104(1) to learn more information regarding a respective game title, request to acquire the respective game title, and so forth. In some instances, and as illustrated, the UI 110(1) may include a first set of icons (e.g., icons 1-6 in FIG. 1) for items associated with a first category (e.g., a first game category). These icons may represent a subset of the available content items associated with the first category.

In some instances, the computing system 108 may include one or more incentive items in a set of candidate content items from which the items displayed on UI 110(1) have been determined. For example, the computing system 108 may determine multiple content items associated with a particular category (“category X” in the example of FIG. 1) as candidate content items for display in UI 110(1) and, as described in more detail herein, determine that the user 104(1) is eligible to be presented an incentive item. The computing system 108 may determine an ordered set of the candidate items. The computing system 108 may then determine a position for the incentive item within the ordered set of candidate items and insert the incentive item into the ordered set of candidate item. The computing system 108 may then determine the content items for display in a particular UI. For example, as shown in FIG. 1, the computing system 108 may determine that an incentive item 5 may be inserted at the fifth position of an ordered set of candidate content items. The computing system 108 may determine to present icons representing candidate content items 1-6 on the UI 110(1), with the icon associated with the incentive item 5 in the fifth position. As shown in this example, the incentive item may be presented in a different manner than a typical content item (here, incentive item 5 is shown in bold, underlined, and with a thicker outline in UI 110(1)). User selection of incentive item 5 may cause the computing system 108 to generate and/or present additional interfaces to the user 104(1) for incentive item and/or bonus item redemption or acquisition, as described in more detail herein.

In another example, the user 104(2) may operate the client device 102(2) to navigate to a webpage or the like associated with the computing system 108 and, in response, the computing system 108 may cause the client device 102(2) to present a UI 110(2) on a display of the client device 102(2). In some instances, this UI 110(2) may include information regarding one or more video games and/or other content items available for acquisition by the user 104(2) and from the computing system 108. For instance, the UI 110(2) may include icons associated with the respective game titles, with these icons being selectable by the user 104(2) to learn more information regarding a respective game title, request to acquire the respective game title, and so forth. In some instances, and as illustrated, the UI 110(2) may include a second set of icons (e.g., icons 7, 5, 9, 8, 11, and 12 in FIG. 1) for items associated with a second category (e.g., a second game category). These icons may represent a subset of the available content items associated with the second category. As shown here, the icons shown for the first category in UI 110(1) may include some, but not necessarily all, of the icons that are included in the second category in UI 110(2).

Here again, the computing system 108 may include one or more incentive items in a set of candidate content items from which the items displayed on UI 110(2) have been determined. For example, the computing system 108 may determine multiple content items associated with a particular category (“category Y” in the example of FIG. 1) as candidate content items for display in UI 110(2) and, as described in more detail herein, determine that the user 104(2) is eligible to be presented an incentive item. The computing system 108 may determine an ordered set of candidate items and a position for the incentive item and then determine the content items for display in a particular UI, as described herein. For example, as shown in FIG. 1, the computing system 108 may determine that an incentive item 8 may be inserted at the fourth position of an ordered set of candidate content items. The computing system 108 may determine to present icons representing candidate content items 7, 5, 9, 8, 11, and 12 on the UI 110(2), with the icon associated with the incentive item 8 in the fourth position. Here again, the incentive item may be presented in a different manner than a typical content item (here, incentive item 8 is shown in bold, underlined, and with a thicker outline in UI 110(2)). User selection of incentive item 8 may cause the computing system 108 to generate and/or present additional interfaces to the user 104(2) for incentive item and/or bonus item redemption or acquisition, as described in more detail herein.

In various examples, categories and/or the game titles may be selected for presentation to a user 104(1) and/or 104(2) based on criteria associated with the user, a user selection, user ad/or system historical data, content item data, and/or the like. For instance, the computing system 108 may use information such as sales data for game titles, preferences of the user, gameplay history, and/or the like for selecting the game titles and/or the categories to present to the users 104. In addition, or in the alternative, the computing system 108 may use this information (e.g., sales data, preferences, gameplay history, etc.) to determine an order or other manner in which to present a set of game titles, such as those game titles associated with a particular sales event or other promotion. The computing system 108 may use this ordered set of game titles or content items as a set of candidate items into which an incentive item may be inserted and from which display items for presentation in a UI may be determined. It is to be appreciated that any other number of content items may be considered for presentation on a UI and that any manner of determined the order of presentation of such items may be utilized. In addition, it is to be appreciated that while this example describes ordering icons based on one or more criteria, it is to be appreciated that the techniques may cause certain icons to be more prominent on the UIs 110 in ways other than ordering, such as by making certain icons larger, highlighting certain icons, or so forth.

FIG. 1 illustrates example components of the computing system 108 for generating the respective UIs 110(1) and 110(2). As illustrated, the computing system 108 may comprise one or more processors 112 (e.g., one or more central processing units (CPU(s)) and computer-readable media 114, as well as components stored thereon for generating UIs, such as example UIs 110(1) and 110(2). The computer-readable media 114 may include volatile and nonvolatile memory, removable and non-removable media implemented in any method or technology for storage of information, such as computer-readable instructions, data structures, program modules, or other data. Such memory includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information, and which can be accessed by a computing device. The computer-readable media 114 may be implemented as computer-readable storage media (“CRSM”), which may be any available physical media accessible by the processor(s) 112 to execute instructions stored on the computer-readable media 114. In one basic implementation, CRSM may include random access memory (“RAM”) and Flash memory. In other implementations, CRSM may include, but is not limited to, read-only memory (“ROM”), electrically erasable programmable read-only memory (“EEPROM”), or any other tangible medium which can be used to store the desired information, which can be accessed by the processor(s) 112.

As illustrated, the computer-readable media 114 may store or otherwise have access to an incentive item determination component 116, a candidate content item determination component 118, a bonus item determination component 120, and/or a UI-generation component 122. In addition, the media 114 may store a library of content items 124, user account and/or profile data 126 storing information associated with users of the computing system 108 that may be used to determine and/or redeem incentive items and/or bonus items, incentive items data 128 that may include data associated with incentive items and related content as described herein, and/or bonus items data 130 that may include data associated with bonus items and related content as described herein.

The incentive item determination component 116 may function to determine incentive items and related data for presentation to a user on a UI. For example, the incentive item determination component 116 may determine, based on data associated with a user (e.g., represented in profile data 126), whether a user is eligible to be presented an incentive item and, if so, one or more incentive items to be presented to a user (e.g. from among a plurality of available incentive items represented in incentive items data 128). For instance, the incentive item determination component 116 may determine whether user 104(1) has had a sufficient level of interaction with the computing system 108 to qualify for an incentive item. Having determined that the user 104(1) qualifies for an incentive item, the incentive item determination component 116 may determine that the incentive item 5 may be presented to the user 104(1) in a UI. The incentive item determination component 116 may also, or instead, determine, in a similar fashion, that the user 104(2) qualifies for an incentive item and that the incentive item 8 may be presented to the user 104(2) in a UI.

The candidate content item determination component 118 may function to determine which content items may be considered for presentation in one or more UIs based on various criteria. For instance, the candidate content item determination component 118 may determine the content items from among the content items data 124 that are associated with a category selected by the user 104(1) and/or based on user 104(1) data represented in profile data 126. The candidate content item determination component 118 may also, or instead, order such content items based on various criteria as described herein so that the content items may be presented in a series of one or more UIs to the user 104(1). The candidate content item determination component 118 may also, or instead, similarly determine the content items from among the content items data 124 that are associated with a category selected by the user 104(2) and/or based on user 104(2) data represented in profile data 126.

The candidate content item determination component 118 may also, or instead, determine whether to insert an incentive item into this ordered set of candidate content items. For instance, the candidate content item determination component 118 may query the incentive item determination component 116 for an incentive item (or an indication thereof) when determining a set of candidate content items. Alternatively or additionally, the incentive item determination component 116 may proactively transmit an incentive item (or an indication thereof) to the candidate content item determination component 118 under various conditions. The candidate content item determination component 118 may receive or retrieve incentive items from the incentive item determination component 116 and/or the incentive items data 128. The candidate content item determination component 118 may insert a received or retrieved incentive item into an ordered set of candidate content items. In various examples, the candidate content item determination component 118 may determine a position within an ordered set of candidate content items at which to insert an incentive item. Alternatively or additionally, the incentive item determination component 116 may provide (e.g., on demand or proactively) this information to the candidate content item determination component 118.

For instance, the candidate content item determination component 118 may determine a set of candidate content items associated with category “X” for presentation to user 104(1) in a UI. The candidate content item determination component 118 may query the incentive item determination component 116 with data indicating the user 104(1), which may respond with incentive item 5 and an incentive item position or preference factor. The candidate content item determination component 118 may insert the incentive item 5 into the set of candidate content items based on the position or preference factor. Similar, the candidate content item determination component 118 may determine a set of candidate content items associated with category “Y” for presentation to user 104(2) in a UI and query the incentive item determination component 116 with data indicating the user 104(2). Based on receiving responsive data from the incentive item determination component 116 indicating an incentive item 8 and an incentive item position or preference factor associated with the user 104(2), the candidate content item determination component 118 may insert the incentive item 8 into the set of candidate content items for the category “Y” based on the associated position or preference factor.

The bonus item determination component 120 may determine, for example based on profile data 126, incentive items data 128, and/or bonus items data 130, whether a user is eligible for a bonus item (e.g., due to sufficient redemption of incentive items) and/or one or more bonus items that may be redeemed by or otherwise associated with a user. For example, the bonus item determination component 120 may determine, in response to detecting a selection of the incentive item 5 by the user 104(1), that the user 104(1) is eligible for a bonus item. The bonus item determination component 120 may further determine one or more bonus items for which the user 104(1) is eligible. In another example, the bonus item determination component 120 may determine, in response to detecting a selection of the incentive item 8 by the user 104(2), that the user 104(2) is not eligible for a bonus item.

The UI-generation component 122 may generate a UIs for presentation on a client device. For example, the UI generation component 122 may receive a set of candidate content items (e.g., that may include one or more incentive items) from the candidate content item determination component 118 and may use this set of candidate content items to generate a UI presenting at least a subset of the candidate content items. The UI-generation component 122 may then provide the UI for presentation on the client device.

Note that in some examples, various functions and/or components may be distributed across multiple devices, including client devices. For example, one or more of the incentive item determination component 116, the candidate content item determination component 118, the bonus item determination component 120, and/or the UI-generation component 122 may be configured on one or both of the client devices 102. Either or both of the client devices 102 may be configured to perform any one or more of the functions described herein (e.g. using the data as described herein) in regard to those and similar components.

To provide an example, the user 104(1) may navigate the client device 102(1) to a webpage associated with a content items offered by the computing system 108. The user 104(1) may select a category on that webpage that may trigger a browser on the client device 102(1) to transmit a request to the computing system 108 for a UI presenting content items associated with that category. This request may include data associated with the user 104(1).

In response to receiving this request, the incentive item determination component 116 may determine that the user 104(1) is eligible for an incentive item. The incentive item determination component 116 may further determine that the incentive item 5 may be presented to the user 104(1) and may determine a preference factor for the incentive item 5. The incentive item determination component 116 may provide this information to the candidate content item determination component 118.

Also in response to receiving this request, the candidate content item determination component 118 may determine the content items associated with the category indicated in the request and an order for such items to generate a set of candidate content items (e.g., based on profile data 126). Based on the incentive item 5 information received from the incentive item determination component 116, the candidate content item determination component 118 may insert the incentive item 5 into the candidate content items at a position determined based on the preference factor received from the incentive item determination component 116.

The candidate content item determination component 118 may provide the ordered set of candidate content items (including the incentive item) to the UI-generation component 122 that may generate and/or provide the UI 110(1) to the client device 102(1) for presentation to the user 104(1). Here, the UI 110(1) includes items associated with category “X,” including typical content items 1-4 and 6 and incentive item 5. UI 110(2) may be generated and presented to the user 104(2) with typical content items 7, 5, 9, 11, and 12 and incentive item 8 using similar techniques by these components and system 108.

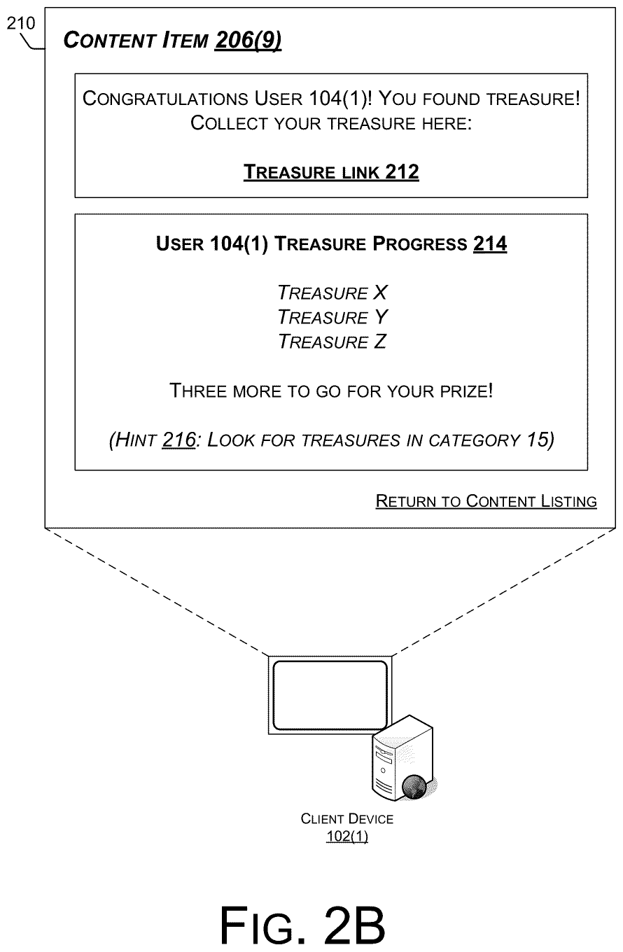

FIG. 2A illustrates details of example UIs 202 and 208 that, for instance, the computing system 108 may provide to client computing device 102(1) or 102(2). As illustrated, the UI 202 may include indications or representations (e.g., icons) associated with content items associated with a category 204. These content items may be ordered and/or otherwise organized based on one or more criteria, such as preferences or a consumption history of a user that initiated a request for the presentation of the UI 202. For example, the UI 202 may include user-selectable icons 206(1), 206(2), 206(3), 206(4), 206(5), and 206(6) corresponding to content items associated with a category 204 and functioning as controls that will initiate requests for the content represented by such icons.

In some instances, these displayed content items may be a subset of an ordered set of candidate content items associated with the category 204. The content items presented in UI 202 may be the highest ranked and/or initial content items in the set of candidate content items and, as such, may have been determined to be the display items for the UI 202. The UI 202 may not include an incentive item, for example, because the computing system 108 did not determine an incentive item to be included in the subset of the ordered set of candidate content items associated with the category 204 that is presented in the UI 202 (e.g., because the associated user is no eligible for an incentive item or because a determined incentive item is not included in this particular subset of the ordered set of candidate content items).

The UI 202 may also include one or more controls and other information. For example, the UI 202 may include informational messages, text, pictures, etc. (e.g. “Look for Treasures!”). The UI 202 may also, or instead, include one or more links or other types of controls that may initiate requests for further UIs and/or other actions. For example, the UI 202 may include a link that may, upon user activation, generate a request for another UI presenting a subsequent subset of the ordered set of candidate content items associated with the category 204 (e.g., “Show more” in UI 202).

FIG. 2A further illustrates a UI 208 that may be generated based on detecting an activation of a control configured on the UI 202. For example, a user may select a link on the UI 202 that generates a request for a UI presenting a subset of the ordered set of candidate content items subsequent to those represented in the UI 202 and associated with the category 204. For instance, the UI 208 may include user-selectable icons 206(7), 206(8), 206(10), 206(11), and 206(12) corresponding to content items associated with a category 204 and functioning as controls that will initiate requests for the content represented by such icons.

The computing system 108 may generate and/or provide the UI 208 in response to this request that may include indications or representations (e.g., icons) associated with additional content items associated with a category 204. These displayed content items may be another (e.g., subsequent) subset of the ordered set of candidate content items associated with the category 204 that were presented in the UI 202. The content items presented in UI 202 may be the next highest ranked and/or subsequent content items in the set based on that set ordering and, as such, may have been determined to be the display items for the UI 208.

The UI 208 may include an incentive content item 206(9), for example, based on the computing system 108 determining that the user associated with the request for the UI 208 qualifies for an incentive item. The computing system 108 may determine, for example, based on the requesting user, a preference factor, and/or other data, that the incentive content item 206(9) may be inserted at the ninth position of the ordered set of candidate content items associated with the category 204. Because the UI 208 includes the seventh through twelfth content items in the ordered set of candidate content items, the incentive item 206(9) may be included in this UI.

As shown here, the incentive content item 206(9) may be represented in a manner that differs from that of non-incentive content items (e.g., shaded with bold italicized text in this example). In other examples, an incentive content item may be represented similarly to other content items (e.g., as a shadowed icon similar to other content item icons), differently from other content items (e.g., as a type of graphical element distinct from those used for content items), or substantially the same different as other content items. Like the UI 202, the UI 208 may also include one or more controls and other information.

FIG. 2B illustrates details of an example UI 210 that the remote computing system 108 may provide to the client computing device 102(1) in response to detecting a selection by the user 104(1) of the incentive content item 206(9) presented in the UI 208 of FIG. 2A. As noted, a content item, incentive item, and/or a representation thereof (e.g., an icon) may function as a control that may generate a request associated with the respective item. In this example, the user 104(1) may have selected the incentive content item 206(9) in the UI 208 being presented to the user by the client device 102(1). In response to this selection, the client device 102(1) may generate a request for transmission to the computing system 108 that requests redemption of an incentive item.

In response to this request, the computing system 108 may generate and/or transmit the UI 210 to the client device 102(1) for presentation to the user 104(1). The UI 210 may be an incentive item redemption interface that allows the user 104(1) to request the incentive content item 206(9). As show in this figure, the UI 210 may include a control or link 212 that will generate a request for credit for the incentive content item 206(9). The UI 210 may include informational text, images, data, etc. associated with the link 212 (e.g., a congratulations message). The 210 may also include additional information, such as progress information 214 that may indicate the progress the user 104(1) has made towards acquiring a bonus item (e.g., remaining incentives needed, incentives captured thus far, etc.). Such additional may also, or instead, include a hint or clue 216 that may assist the user 104(1) in locating one or more additional incentive content items (e.g., a suggested category for further exploration).

The link 212 may include and/or be associated with one or more security measures intended to limit acquisition of the associated incentive item to an appropriate user (e.g. user 104(1)). For example, the link 212 may be associated with a token encrypted using a secret key available only to the computing system 108 and may be decryptable only using the this secret key. Thus, when the user 104(1) clicks on the link 212, the client device 102(1) may (e.g., automatically) transmit the encrypted token to the computing system 108 that may then decrypt the token to verify that the user 104(1) is associated with the incentive content item 206(9). If, however, the link 212 is activated by a different user, the information (e.g., user information) transmitted with the token will not match the information in the decrypted token and retrieval of the incentive content item 206(9) using the link 212 will not be possible.

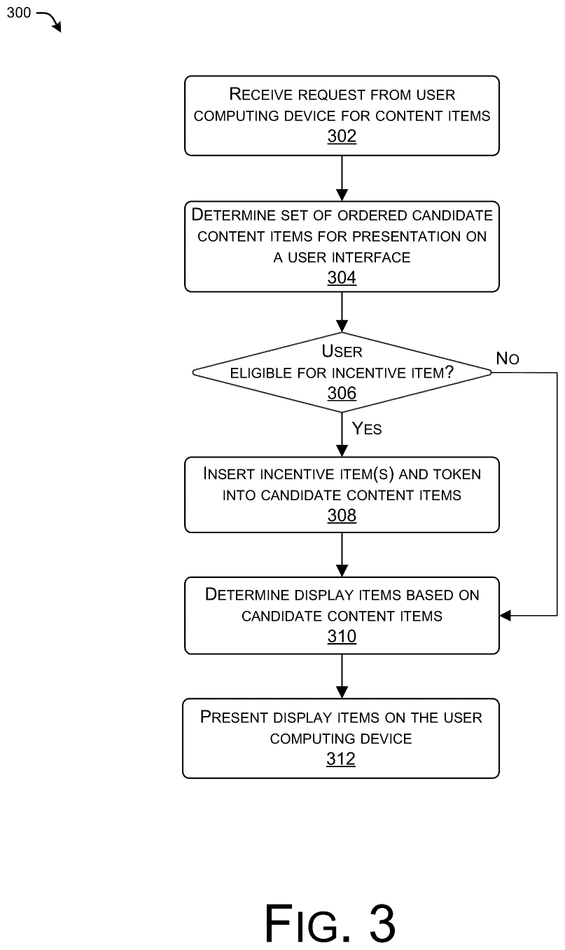

FIG. 3 illustrates a flow diagram of an example process 300 for determining content items for presentation to a user on a user interface. This process, and each process described herein, is illustrated as a collection of blocks in a logical flow graph, which represent a sequence of operations that can be implemented in hardware, software, or a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes. In some instances, the computing system 108 may be configured to perform some or all of the operations, although in other instances other devices may additionally or alternatively perform some or all of the operations. For instance, some or all of the techniques described herein may be performed on the client devices themselves in some instances.

At an operation 302, the computing system 108 may receive a request from a user computing device, such as client device 102(1) or 102(2), for one or more content items. For example, the computing system 108 may receive a request for a UI the presents content items associated with a particular content category, such as a request to browse or explore action games, multiplayer games, on-sale games, etc. This request may include other data, such as user identification data, timestamp data, authentication data, encryption data, etc.

At an operation 304, the computing system 108 may determine a set of candidate content items for presentation to the requesting user. For example, the computing system 108 may retrieve data associated with (e.g., all) content items associated with a category indicated in the received request. Alternatively or additionally, the computing system 108 may retrieve candidate content item data based on user data, such as user profile information, user account information, historical interaction information, user preferences, etc. Other information may also, or instead be used to determine candidate content items for presentation to a user in response to the request received at the operation 302.

Further at the operation 304, the computing system 108 may order the candidate content items to determine a set of ordered candidate content items. The ordering may be based on one or more criteria, such as relevancy, recency (e.g., newest or oldest items prioritized, prioritized by availability date), price (e.g., highest to lowest or vice versa), popularity, user preferences, historical interaction information, etc.

At an operation 306, the computing system 108 may determine whether the user is eligible for an incentive item and/or whether an incentive item is to be included in the set of ordered candidate content items that may be used to determine the items displayed on one or more UIs. For example, incentive items may be provided to users based on user interaction. User interaction may be determined based on a variety of criteria. In some examples, a threshold quantity of user interaction may be required before an incentive item is made available to a user.

For example, user interaction may be determined based on an amount of interaction time associated the user. For instance, the system may determine whether the user has interacted with the computing system 108 (e.g., played games, been logged in, etc.) for at least a threshold period of time over a particular time period (e.g., a week, 30 days, 60 days, etc.). In another example, user interaction may be determined based on a quantity of interaction associated the user. For instance, the system may determine whether the user has interacted with a threshold number of distinct programs or items (e.g., played a sufficient number of distinct games) over a particular time period (e.g., a week, 30 days, 60 days, etc.). In another example, user interaction may be determined based on an interaction quality associated the user. For instance, the system may determine whether the user has spent a threshold amount of money interacting with the system, watched a threshold number or advertisements, is a particular type of member, etc. Any other criteria and/or any combination thereof may be used by the computing system 108 to determine whether the user is eligible for an incentive item at the operation 306.

If the computing system 108 determines that user is not eligible for an incentive item, the computing system 108 may use the set of candidate content items without inserted incentive items to determine the display items for a UI at an operation 310. For example, the computing system 108 may determine a number of content items that may be represented in a particular type of UI and select, in order, that number of items from the set of candidate content items for display on the UI. The computing system 108 may then, at an operation 312, generate and/or provide the UI to a user computing device for presentation to the user.

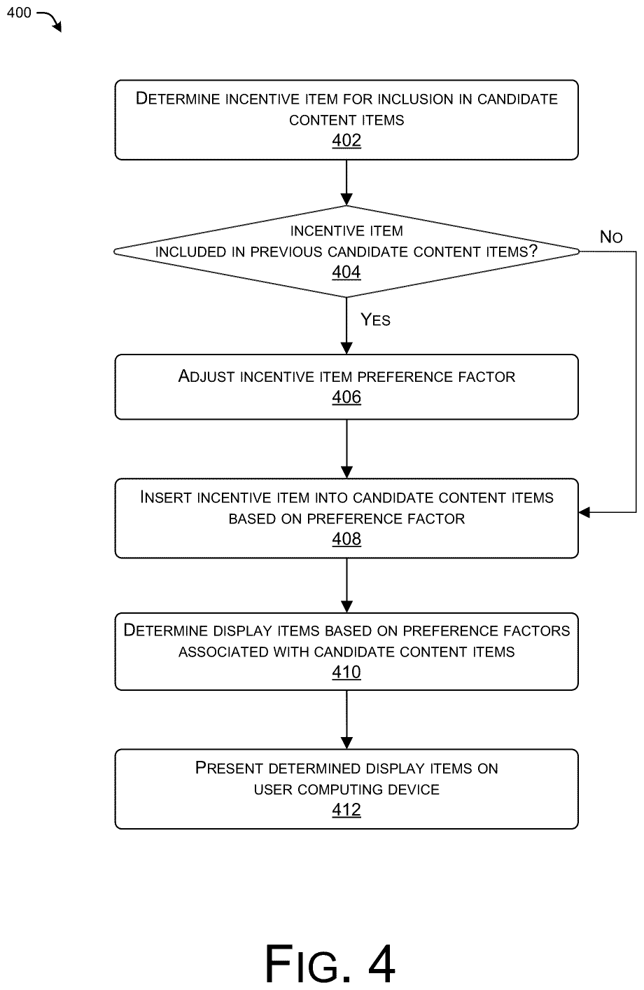

If the computing system 108 determines at the operation 305 that user is eligible for an incentive item, at an operation 308 the computing system 108 may insert one or more incentive items into the set of candidate content items. The computing system 108 may also, or instead, generate an encrypted token for the user (e.g., based on user data) and associate the token with the incentive item. In various examples, the remote computing system may generate a link associated with the encrypted token that will, when activated, transmit the encrypted token back to the system allowing the system to verify that the appropriate user is attempting to redeem the incentive item. The computing system 108 may insert the incentive item, the token, the link, and/or any combination thereof into the set of candidate content items. In various examples, the computing system 108 may determine an incentive item, multiple incentive items, associated token(s) and/or link(s), and/or a placement or position for the incentive item(s), token(s), and/or link(s) in the set of candidate content items using a variety of techniques (see, e.g., FIG. 4 and related discussion).

With the incentive included in the set, the computing system 108 may use the set of candidate content items to determine the display items for a UI at the operation 310. The display items determined may or may not include the incentive item. For example, as noted, the computing system 108 may determine a number of content items that may be represented in a particular type of UI and select, in order, that number of items from the set of candidate content items for display on the UI. The incentive item may be in a portion of the set of candidate content items that is outside of the number of items in the set of candidate content items selected for display on the UI. In such examples, the incentive item may be selected for a subsequent UI. The computing system 108 may then, at an operation 312, generate and/or provide the UI to a user computing device for presentation to the user.

FIG. 4 illustrates a flow diagram of an example process 400 for determining content items, including an incentive item, for presentation to a user on a user interface. This process may also be performed by the remote computing system 108, a client device, or any other computing device. At an operation 402, the computing system 108 may determine that one or more incentive items are to be included among candidate content items considered for presentation to a user. For example, the computing system 108 may determine that an incentive item is to be included in a set of ordered candidate content items used to determine display items for one or more UIs in a series of UIs. The determined incentive item may have an associated preference factor that may be used to determine position of the incentive item among ordered candidate content items as described herein.

At an operation 404, the computing system 108, may determine if the one or more incentive items have been included in previous candidate content items. In various examples, a same incentive item may be included among candidate content items that may presented to a user until it is selected by the user and/or until the incentive item expires and/or times out. For instance, once a user becomes eligible for an incentive item, the incentive item may be included in each subsequently generated UI that presents associated content items until the item is selected by the user. An incentive item may also have an expiration time or a lifespan. In such examples, if the item is not selected by the user before the expiration time or lifespan, the item may be removed from consideration for inclusion in a set of candidate content items.

If, at operation 404, the computing system 108 determines the incentive item has not been included in previous candidate content items, the process 400 may move to an operation 408 where the incentive item may be inserted into the current candidate content items using its current (e.g., unchanged, default) preference factor. In various examples, a preference factor may be used to increase the likelihood that a particular incentive item will be presented to a user. In such examples, a greater preference factor may result on an incentive item being included in earlier UIs than a lesser preference factor (e.g., a preference factor may be used as a denominator of a top fraction of candidate content items into which the incentive item is to be inserted, as described herein). In such examples, a default preference factor may be used if the incentive item has not been inserted into candidate content items (e.g., within a recent period of time). A default preference factor may be a relatively low preference factor that may essentially result in a random selection of a position for the incentive item within the candidate content items.

If, at operation 404, the computing system 108 determines that the incentive item has been included in previous candidate content items, at an operation 406 the preference factor for the incentive item may be adjusted (e.g., increased, decreased, incremented, decremented, etc.). By adjusting the preference factor, the likelihood that the incentive item will be presented to a user earlier in a series of UIs may be increases (or assured). For example, an increased preference factor may ensure that an incentive item is positioned in a higher portion of the set of candidate content items (e.g., where a preference factor may be used as a denominator of a top fraction of candidate content items into which the incentive item is to be inserted, as described herein). As the preference factor increases, so may the probability that the incentive item is presented to the user. In some examples, the preference factor may have a maximum or minimum value that ensures it will be included on the first UI presented to a user in a series of UIs. The preference value and techniques of adjusting preference values over time and/or iterations of candidate content item set generation may be adjusted based on system operator goals.

At an operation 408, the incentive item may be inserted into the candidate content items based on the (default or adjusted) preference factor. In various examples, a position of the incentive item within an ordered set of candidate content items may be determined based on the preference factor and the remaining content items may be adjusted to accommodate this positioning.

At an operation 410, the computing system 108 may determine a number of display items for a particular UI based on the candidate content items. For example, the computing system 108 may determine that there will be a particular number of UIs required to display all of the content items associated with a particular category (e.g., 10 UIs that each display 10 items will be required to display a total of 100 items). The computing system 108 may determine, in order, the top number of items for the first UI, and the next number of items for a subsequent UI, and so forth. The computing system 108 may then, at an operation 412, generate, transmit, and/or otherwise provide the UI with the determined display items to a user computing device, such as client device 102(1) or 102(2).

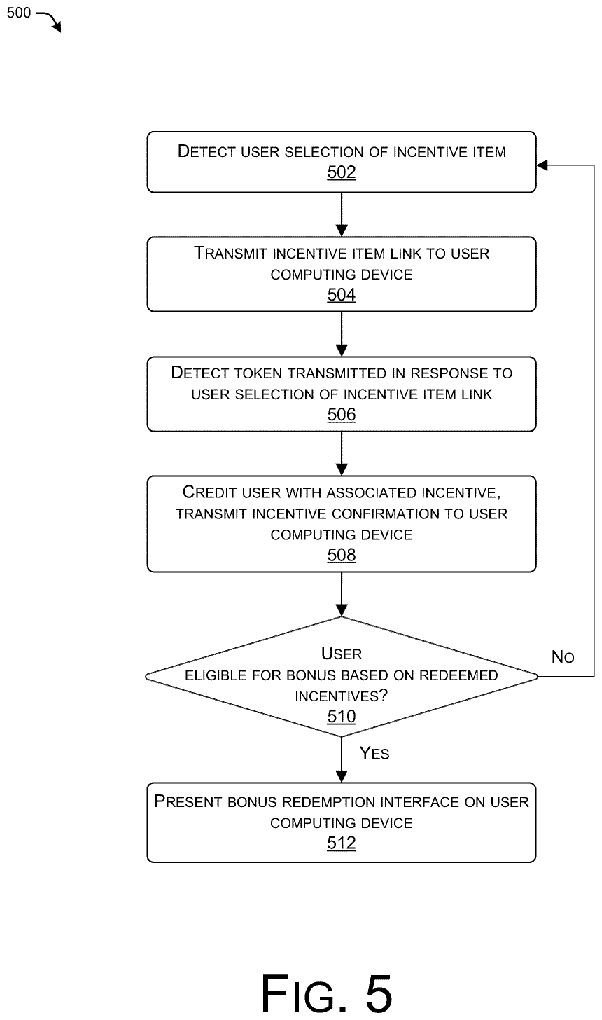

FIG. 5 illustrates a flow diagram of an example process 500 for associating data representing incentive items and bonus items with users. This process may be performed by the remote computing system 108, a client device, or any other computing device. At an operation 502, the computing system 108 may detect a user selection of an incentive item (e.g., incentive content item 206(9) of FIG. 2A). For example, the user may select, using a client device, an incentive content item from among a set of display items presented on a UI and determined from a set of ordered candidate content items (e.g., as described herein). The indication of a user selection may be a request of a UI (e.g. webpage) that may include user information, item information, user device, information, etc.

In response to detecting this user selection, at an operation 504, the computing system 108 may transmit or otherwise provide a link to the user (e.g., to the client device associated with the user). For example, the computing system 108 may generate a UI, such as the UI 210 of FIG. 2B, that includes a link, control, and/or instructions to transmit an encrypted token to the computing system 108 (e.g., the link may be embedded in the UI with such instructions). As described herein, this token may be based on the incentive item and/or a token associated with the incentive item.

When the appropriate user activates this link, for example, at an operation 506, the user's device may (e.g., automatically) transmit an associated encrypted token to the computing system 108 to access the incentive item. The token may be transmitted with user and/or incentive item data. The computing system 108 may decrypt the token and compare the user and/or incentive item data represented therein to the user and/or incentive item data received with the encrypted token to ensure that they match (e.g., the appropriate user is redeeming the incentive item). Because an unauthorized user will not have appropriate associated user data and/or incentive data, the computing system 108 will recognize that the token does not match the unauthorized user and/or incentive and will therefore not credit the incentive item to the unauthorized user.

At an operation 508, the computing system 108 may, in response to detecting user activation of the link at the operation 506 and verifying the user using the token, credit the user with the associated incentive (e.g., add points to the user account, associate the user with a puzzle piece or map section, etc.). The computing system 108 may also notify the user that the user that the incentive has been rewarded.

At an operation 510, the computing system 108 may determine if the user is eligible for a bonus item, for example due to the redemption of the incentive item at operation 508. In various examples, a user may have the opportunity to acquire multiple incentive items. If a sufficient number (e.g., all) of such incentive items are collected, the user may be eligible for a bonus item. In other examples, a single incentive item may result in the award of a bonus item. The computing system 108 may track the incentive items and bonus items associated with a particular user (e.g., in user account and/or profile data).

If the computing system 108 determines that the user is not eligible for a bonus item (e.g., due to insufficient incentive item acquisition), the system may return to operation 502 to detect subsequent incentive items selections. If, however, the computing system 108 determines that the user is eligible for a bonus item (e.g., due to sufficient incentive item acquisition), at operation 512 the computing system 108 may generate, transmit, and/or other present the user with a bonus item redemption UI that may allow the user to acquire a bonus item. The bonus item UI may provide a link to a bonus item, in some examples similar to the encrypted links described herein for use in redeeming incentive items. Alternatively, the bonus item UI may provide multiple bonus items from which the user may select one or more bonus items. Upon selection of such one or more bonus items, the computing system 108 may generate or otherwise provide a subsequent UI that may include a link to selected bonus item (e.g., encrypted as described herein for use in redeeming incentive items). Alternative means of allowing selection of and/or providing one or more bonus items may be implement in various examples.

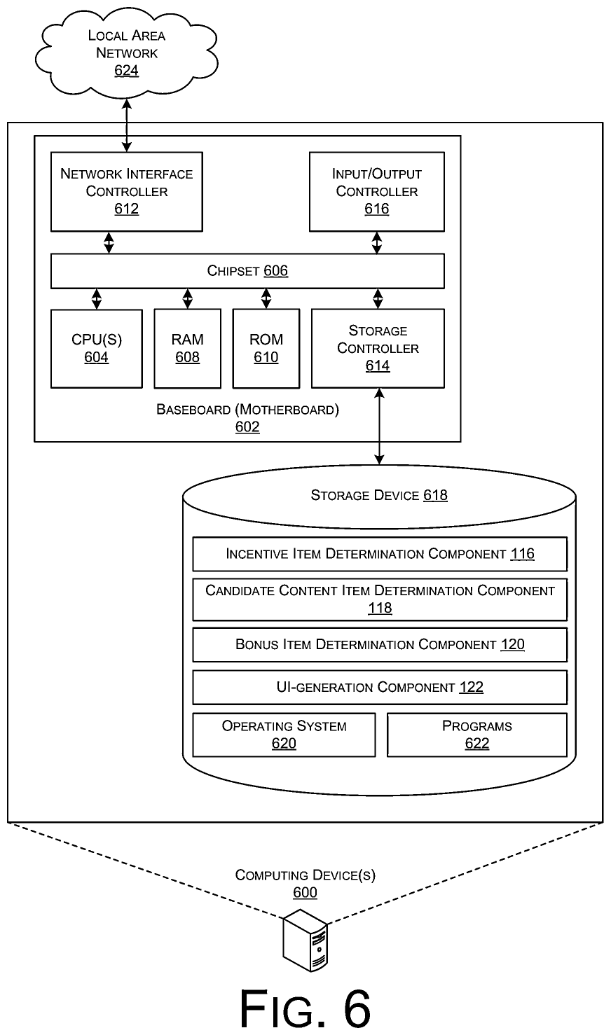

FIG. 6 is a computer architecture diagram showing an illustrative computer hardware architecture for implementing a device 600 that can be utilized to implement aspects of the various technologies presented herein. The computing system 108 and/or the client devices 102 described herein may include some or all of the components discussed below with reference to the device 600.

The computing resources described herein may be provided by a cloud computing network, data center, or the like can be data processing resources such as virtual machine (VM) instances or hardware computing systems, database clusters, computing clusters, storage clusters, data storage resources, database resources, networking resources, and others. Some of the devices 600 can also be configured to execute a resource manager capable of instantiating and/or managing the computing resources. In the case of VM instances, for example, the resource manager can be a hypervisor, or another type of program configured to enable the execution of multiple VM instances on a single server device 600. Devices 600 in a data center can also be configured to provide network services and other types of services.

The device 600 includes a baseboard 602, or “motherboard,” which is a printed circuit board to which a multitude of components or devices can be connected by way of a system bus or other electrical communication paths. In one illustrative configuration, one or more central processing units (CPUs) 604 operate in conjunction with a chipset 606. The CPUs 604 can be standard programmable processors that perform arithmetic and logical operations necessary for the operation of the device 600.

The CPUs 604 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 606 provides an interface between the CPUs 604 and the remainder of the components and devices on the baseboard 602. The chipset 606 can provide an interface to a RAM 608, used as the main memory in the device 600. The chipset 606 can further provide an interface to a computer-readable storage medium such as a read-only memory (ROM) 610 or non-volatile RAM (NVRAM) for storing basic routines that help to startup the device 600 and to transfer information between the various components and devices. The ROM 610 or NVRAM can also store other software components necessary for the operation of the device 600 in accordance with the configurations described herein.

The device 600 can operate in a networked environment using logical connections to remote computing devices and computer systems through a network, such as a local area network 624. The chipset 606 can include functionality for providing network connectivity through a Network Interface Card (NIC) 612, such as a gigabit Ethernet adapter. The NIC 612 is capable of connecting the device 600 to other computing devices over the network. It should be appreciated that multiple NICs 612 can be present in the device 600, connecting the computer to other types of networks and remote computer systems.

The device 600 can be connected to a storage device 618 that provides non-volatile storage for the computer. The storage device 618 can store an operating system 620, programs 622, and data, which have been described in greater detail herein. The storage device 618 can be connected to the device 600 through a storage controller 614 connected to the chipset 606. The storage device 618 can consist of one or more physical storage units. The storage controller 614 can interface with the physical storage units through a serial attached SCSI (SAS) interface, a serial advanced technology attachment (SATA) interface, an FC interface, or other type of interface for physically connecting and transferring data between computers and physical storage units.

The device 600 can store data on the storage device 618 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 618 is characterized as primary or secondary storage, and the like.

For example, the device 600 can store information to the storage device 618 by issuing instructions through the storage controller 614 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The device 600 can further read information from the storage device 618 by detecting the physical states or characteristics of one or more particular locations within the physical storage units.

In addition to the mass storage device 618 described above, the device 600 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 600.

By way of example, and not limitation, computer-readable storage media can include volatile and non-volatile, removable and non-removable media implemented in any method or technology. Computer-readable storage media includes, but is not limited to, RAM, ROM, erasable programmable ROM (EPROM), electrically-erasable programmable ROM (EEPROM), flash memory or other solid-state memory technology, compact disc ROM (CD-ROM), digital versatile disk (DVD), high definition DVD (HD-DVD), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 618 can store an operating system 620 utilized to control the operation of the device 600. According to one embodiment, the operating system comprises the LINUX operating system. According to another embodiment, the operating system comprises the WINDOWS® SERVER operating system from MICROSOFT Corporation of Redmond, Washington.

According to further embodiments, the operating system can comprise the UNIX operating system or one of its variants. It should be appreciated that other operating systems can also be utilized. The storage device 618 can store other system or application programs and data utilized by the device 600.

In one embodiment, the storage device 618 or other computer-readable storage media is encoded with computer-executable instructions which, when loaded into the device 600, transform the computer from a general-purpose computing system into a special-purpose computer capable of implementing the embodiments described herein. These computer-executable instructions transform the device 600 by specifying how the CPUs 604 transition between states, as described above. According to one embodiment, the device 600 has access to computer-readable storage media storing computer-executable instructions which, when executed by the device 600, perform the various processes described above with regard to FIGS. 3-5. The device 600 can also include computer-readable storage media having instructions stored thereupon for performing any of the other computer-implemented operations described herein.

The device 600 can also include one or more input/output controllers 616 for receiving and processing input from a number of input devices, such as a keyboard, a mouse, a touchpad, a touch screen, an electronic stylus, or other type of input device. Similarly, an input/output controller 616 can provide output to a display, such as a computer monitor, a flat-panel display, a digital projector, a printer, or other type of output device. It will be appreciated that the device 600 might not include all of the components shown in FIG. 6, can include other components that are not explicitly shown in FIG. 6, or might utilize an architecture completely different than that shown in FIG. 6.

The device 600 may also store, in the storage device 618, one or more of an incentive item determination component 116, a candidate content item determination component 118, a bonus item determination component 120, a UI-generation component 122, and/or additional elements described above with reference to FIGS. 1-5.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative of some embodiments that fall within the scope of the claims of the application.

1. A method comprising:
receiving, from a computing device associated with a user, a request for content associated with a content category;
determining, based at least in part on the content category, a plurality of content items;
determining, based at least in part on the user, an incentive item;
ordering the plurality of content items to determine an ordered set of candidate content items;
determining a preference factor for the incentive item based at least in part on historical user interaction data associated with a first graphical user interface presenting a first plurality of user-selectable controls associated with at least a subset of the plurality of content items;
generating an encrypted token for the incentive item using a secret key associated with the user;
generating a user-selectable control comprising the encrypted token that, when activated, causes the computing device to transmit the encrypted token for user verification and retrieval of the incentive item;
generating a second plurality of user-selectable controls corresponding to the ordered set of candidate content items;
determining, based at least in part on the preference factor, a position of the user-selectable control among the second plurality of user-selectable controls;
inserting the user-selectable control into the second plurality of user-selectable controls at the position to generate candidate user-selectable controls;
determining a subset of the candidate user-selectable controls for presentation on a second graphical user interface;
generating the second graphical user interface comprising the subset of the candidate user-selectable controls; and
transmitting one or more instructions to the computing device to cause the computing device to display the second graphical user interface.

2. The method of claim 1, further comprising:
detecting a user selection of the user-selectable control; and
causing the computing device to display a third graphical user interface comprising a link associated with the encrypted token.

3. The method of claim 2, further comprising receiving the encrypted token from the computing device in response to activation of the link.

4. The method of claim 1, wherein the subset of the candidate user-selectable controls comprises the user-selectable control.

5. The method of claim 1, further comprising increasing the preference factor based at least in part on detecting a user selection of a candidate user-selectable control from among the subset of the candidate user-selectable controls that is not the user-selectable control.

6. The method of claim 5, further comprising;
determining, based at least in part on the preference factor, a second position of the user-selectable control among the second plurality of user-selectable controls;
inserting the user-selectable control into the second plurality of user-selectable controls at the second position to generate second candidate user-selectable controls;
determining a second subset of the second candidate user-selectable controls for presentation on a third graphical user interface;
generating the third graphical user interface comprising the second subset of the second candidate user-selectable controls; and
transmitting one or more second instructions to the computing device to cause the computing device to display the third graphical user interface.

7. The method of claim 6, wherein the second subset of the second candidate user-selectable controls comprises the user-selectable control.

8. A system comprising:
one or more processors; and
one or more computer-readable media storing computer-executable instructions that, when executed, cause the one or more processors to perform operations comprising:
determining an incentive item based at least in part on a user associated with a request for content;
determining a preference factor for the incentive item based at least in part on historical user interaction data associated with a first graphical user interface presenting a plurality of first user-selectable controls associated with at least a subset of a plurality of content items associated with the content;
generating an encrypted token for the incentive item using a secret key associated with the user;
generating a user-selectable control comprising the encrypted token that, when activated, causes a user computing device to transmit the encrypted token for user verification and retrieval of the incentive item;
generating a second plurality of user-selectable controls corresponding to the plurality of content items;
determining a position for the user-selectable control within the plurality of user-selectable controls based at least in part on the preference factor;
inserting the user-selectable control at the position within the second plurality of user-selectable controls to generate candidate user-selectable controls; and
generating a second graphical user interface comprising a subset of the candidate user-selectable controls at the user computing device.

9. The system of claim 8, wherein the operations further comprise
generating a third graphical user interface comprising a link associated with the encrypted token in response to detecting a user selection of the user-selectable control.

10. The system of claim 9, wherein the operations further comprise receiving the encrypted token from the user computing device in response to a second user selection of the link.

11. The system of claim 10, wherein the subset of the candidate user-selectable controls comprises the user-selectable control.

12. The system of claim 8, wherein the operations further comprise:
detecting a user selection of a second user-selectable control from among the subset of the candidate user-selectable controls; and
based at least in part on detecting the user selection of the second user-selectable control, increasing the preference factor.

13. The system of claim 12, wherein the operations further comprise:
determining a second position for the user-selectable control within the second plurality of user-selectable controls based at least in part on the increased preference factor;
inserting the user-selectable control at the second position within the second plurality of user-selectable controls to generate second candidate user-selectable controls; and
generating a third graphical user interface comprising a second subset of the second candidate user-selectable controls at the user computing device.

14. The system of claim 8, wherein the operations further comprise ordering the second plurality of user-selectable controls based on at least one of:
a user preference;
historical user data;
content item availability dates; or
content item prices.

15. One or more computer-readable media storing computer-executable instructions that, when executed, cause one or more processors to perform operations comprising:
receiving a request for content associated with a content category;
determining a plurality of content items associated with the content category;
determining an incentive item based at least in part on a user indicated in the request;
determining a preference factor for the incentive item based at least in part on historical user interaction data associated with a first graphical user interface presenting a first plurality of user-selectable controls associated with at least a subset of the plurality of content items;
generating an encrypted token for the incentive item using a secret key associated with the user;
generating a user-selectable control comprising the encrypted token that, when activated, causes a user computing device to transmit the encrypted token for user verification and retrieval of the incentive item;
generating a second plurality of user-selectable controls corresponding to the plurality of content items;
determining a position for the user-selectable control within the second plurality of user-selectable controls based at least in part on the preference factor;
inserting the user-selectable control at the position within the second plurality of user-selectable controls to generate candidate user-selectable controls;
determining a subset of the candidate user-selectable controls;
generating a second graphical user interface comprising the subset of the candidate user-selectable controls; and
transmitting instructions to the user computing device causing the user computing device to display the second graphical user interface.

16. The one or more computer-readable media of claim 15, wherein determining the subset of the candidate user-selectable controls is based at least in part on a quantity of controls capable of being represented on the second graphical user interface.

17. The one or more computer-readable media of claim 15, wherein the operations further comprise:
detecting a user selection of the user-selectable control; and
based at least in part on detecting the user selection of the user-selectable control, transmitting instructions to the user computing device causing the user computing device to display a third graphical user interface comprising a link for acquiring the incentive item.

18. The one or more computer-readable media of claim 17, wherein the third graphical user interface further comprises information associated with locating a second incentive item.

19. The one or more computer-readable media of claim 17, wherein the third graphical user interface further comprises information associated with incentive item acquisitions associated with the user.

20. The one or more computer-readable media of claim 15, wherein the second graphical user interface further comprises a second user-selectable control for transmitting a second request for a third graphical user interface comprising a second subset of the candidate user-selectable controls.
